(19) United States
(12) Patent Application Publication
(10) Pub. No.: US 2014/0331839 A1
(43) Pub. Date: Nov. 13, 2014

(54) PRECISION RAPID DADO TOOL

(71) Applicant: Calvin Noguchi, Thornton, CO (US)

(72) Inventor: Calvin Noguchi, Thornton, CO (US)

(21) Appl. No.: 14/275,876

(22) Filed: May 12, 2014

Related U.S. Application Data
(60) Provisional application No. 61/822,194, filed on May 10, 2013.

(51) Int. Cl. B27B 5/29

(52) U.S. Cl. CPC B27B 5/29
USPC 83/409

(57) ABSTRACT

A precision rapid dado tool utilizes a sled and a carrier in order to efficiently create dado joins of varying sizes with a table saw and regular blade. The sled is designed to slide on top of the saw. The carrier rests inside the sled and can slide left and right in the sled in order to allow the workpiece mounted therein to move left and right relative to the sled and the saw blade. A measuring gauge is used to set the width of the dado slot that will be cut into the workpiece. The tool streamlines the cutting of left and right cuts and then the carrier can slide left and right in the sled to remove the center material, and the slot on one workpiece is formed. After repeating on the second piece, the two slots can be joined and the dado is complete.

### CROSS-REFERENCE TO RELATED APPLICATIONS

This application claims the benefit of U.S. Provisional Application No. 61/822,194 entitled PRECISION RAPID DADO TOOL and filed on May 10, 2013, which is specifically incorporated by reference herein for all that it discloses and teaches.

### TECHNICAL FIELD

The present invention relates generally to the field of wood-working; more particularly, to the field of wood joinery; and, more particularly still, to a precision rapid dado tool.

### BACKGROUND

Since the early days of woodworking and carpentry, craftsmen have worked to improve their art in a number of ways. In particular, somewhat simple, repetitive tasks have been targeted as areas for improvement, and specialized tools and jigs have been developed to increase the rapidity and quality of such work. For example, when creating various woodworking joints, a number of jigs or custom-tools have been developed; examples include dove-tail jigs, mortise and tenon jigs, finger jigs, etc.

In the area of dado creation, although a number of special dado tools have been invented, the prior art leaves much to be desired. When two lengths of wood are to be joined to each other—especially when a ninety degree, overlapping joint is desired—a dado joint is often used. For example, a frame having four sides and overlapping corners can use dado joins. A slot or trench is cut across one or both pieces of wood to be joined near each corner. It is preferred to make the slot depth equal to one half the depth of each board to be joined. The slots are then overlapped and the pieces pressed into each other to make the joint. Glue, nails, screws, etc. can then be used to make the joint permanent. A traditional method of cutting these slots involves using a table saw with a circular saw blade to make guide cuts at each side of the dado slot and then make a series of repetitive cuts between the guide cuts to remove all of the material therebetween. In order to increase the speed of this operation, two different types of saw blade styles have been developed.

The first type is known as a stacked dado set. It consists of an apparatus having two outside saw blades attached on either side of a set of inner chippers. As the dado set turns in the table saw, the two outside blades cut the dado guide cuts while the chippers simultaneously remove the material therebetween. Although this apparatus allows for the quick creation of dado slots, they are necessarily of a fixed width; as the width of the dado set is determined by the combined width of the two outside saw blades plus the width of the chippers. If the woodworker requires a smaller or larger width dado cut, then he or she has to install smaller or larger width chippers between the outside blades. Switching the width of the dado set then becomes quite time consuming and it can be difficult to exactly match the width of the resulting dado cut with the width of the boards that are to be joined. This results in either a too tight fit (which can cause the boards to split or crack when joined) or a too loose fit (which reduces the strength of the joint and leaves unseemly gaps in the joint).

The second type of dado saw blade is called a wobble blade or wobble dado. In this apparatus, a circular saw blade is mounted on a complex hub device that varies the angle of the blade on the mounting shaft. The width of the dado slot increases as said angle deviates further from being perpendicular to the shaft. Dado width adjustment is possible with this apparatus, but it can be difficult to set the wobble blade to precisely the desired width because tightening of the blade on the shaft can change the angle, and thus, the width of the resulting dado cut. Furthermore, because of the “wobbling” of the blade, the bottom of the dado slot that results is often not a smooth, flat surface, which may reduce the quality of the resulting joint.

In the prior art discussed above, adjustment of the dado width can be time consuming and it is often difficult to attain precisely the dado slot width desired. Furthermore, since both require that a special dado saw blade be installed on the table saw, the woodworker is often forced to constantly change blades back and forth as other project cuts require a regular saw blade be used in place of the dado set or wobble blade. What is needed is a tool that allows for precise, rapid dado cuts to be made without requiring a change of saw blades or time-consuming adjustments.

### SUMMARY

A precision rapid dado tool utilizes a sled having a front fence, a sled base, and a rear fence. The sled is designed to slide on top of a table saw and be operated back and forth through the use of a standard cross-cut sled. The cross-cut sled is a standard table saw accessory that is guided by a runner fastened under it that slides in a miter slot on the top of the table. By engaging the sled with the cross-cut sled, the entire sled can be kept perpendicular to the saw blade and moved back and forth in line with the plane of the blade.

Inside the sled rests the carrier. The carrier comprises the right side carrier base, the left side carrier base, the adjustable vertical carrier member, the adjustment track, the fixed vertical carrier member, and the right stop. The entire carrier can slide left and right in the sled in order to allow the workpiece to move left and right relative to the sled and the saw blade. The workpiece can be held firmly on top of the carrier via a plurality of hold-downs which can be adjustable forward and backward along a plurality of T-tracks. This adjustment is useful in order for the hold-downs to be able to fit workpieces of varying size.

A measuring gauge is used to quickly and easily set the width of the dado slot that will be cut into the workpiece. This is accomplished by loosening the locking knobs, placing the second workpiece (the one that will fit inside the dado cut on the first workpiece) between the gauge and the blade guard, and then locking the measuring gauge in place by locking the locking knobs in place. The second workpiece is then removed and placed aside. The first workpiece is placed in the carrier with a right alignment mark aligned with the saw blade and then the first workpiece is locked in place via the hold-downs. The carrier is in the left most position at this point with the right stop contacting the sled.

The measuring gauge knobs act as a tensioning device: they can be loosened or tightened to decrease or increase, respectively, the tightness of the connection between the carrier and the sled. When the knobs are tightened onto the ends of the bolts, the rear fence is squeezed between the adjustable vertical carrier member and the measuring gauge. If the knobs are over-tightened, the carrier will no longer be free to slide within the sled.

The woodworker operates the precision rapid dado tool by grasping the handle and pushing the sled forward onto the blade of the table saw. The blade will have been previously aligned with the blade slot so that the blade does not contact any portion of the sled. The blade guard extends to the rear of the rear fence and covers the blade; which would otherwise appear from the rear fence when the sled is pushed forward. The blade guard can be a constructed using a clear material so that the woodworker can see the blade therein and then knows to stop pushing the sled forward.

As the tool is pushed forward, the blade makes the right alignment cut. The tool can then be pulled backward. The carrier is then slid to the right until the measuring gauge contacts the blade guard, at which point the left alignment mark will then be lined up with the blade. The reason the left and right alignment marks are automatically lined up is because the proper dado width was measured by the tool when the second workpiece was placed between the measuring gauge and the blade guard and the correct alignment mark was lined up with the blade when the first workpiece was locked down onto the carrier with the hold-downs.

At this point, the tool can be slid forward once more in order to make the left alignment cut. After that cut is made, the woodworker draws the tool backwards until the workpiece clears the blade. Then the sled can be slid forward in small increments with the carrier being slid left and right to gradually hog out the material from between the two alignment cuts. This process is repeated until the entire dado cut has been made.

The first workpiece can then be removed from the carrier and the locking knobs loosened. The first workpiece can then be placed between the measuring gauge and the blade guard in order to set the appropriate dado cut width for the second workpiece. The steps above are then repeated with the second workpiece locked into the carrier. Once the second dado cut is complete, the two workpieces can be joined together and the dado is complete.

### BRIEF DESCRIPTION OF THE DRAWINGS

FIG. 1 illustrates a perspective front view of an exemplary embodiment of a precision rapid dado tool;

FIG. 2 illustrates a front elevation view of an exemplary embodiment of a precision rapid dado tool;

FIG. 3 illustrates a back elevation view of an exemplary embodiment of a precision rapid dado tool;

FIG. 4 illustrates a right side elevation view of an exemplary embodiment of a precision rapid dado tool;

FIG. 5 illustrates a left side elevation view of an exemplary embodiment of a precision rapid dado tool;

FIG. 6 illustrates a top plan view of an exemplary embodiment of a precision rapid dado tool;

FIG. 7 illustrates a bottom plan view of an exemplary embodiment of a precision rapid dado tool; and

FIG. 8 illustrates a perspective back view of an exemplary embodiment of a precision rapid dado tool.

FIG. 9 illustrates an exemplary embodiment of employing a precision rapid dado tool to create a dado joint; and

FIG. 10 illustrates an exemplary embodiment of employing a precision rapid dado tool to create a dado joint.

### DETAILED DESCRIPTION

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples.

Exemplary embodiments are described below in the accompanying Figures. The following detailed description provides a comprehensive review of the drawing Figures in order to provide a thorough understanding of, and an enabling description for, these embodiments. One having ordinary skill in the art will understand that in some cases well-known structures and functions have not been shown or described in detail to avoid unnecessarily obscuring the description of the embodiments.

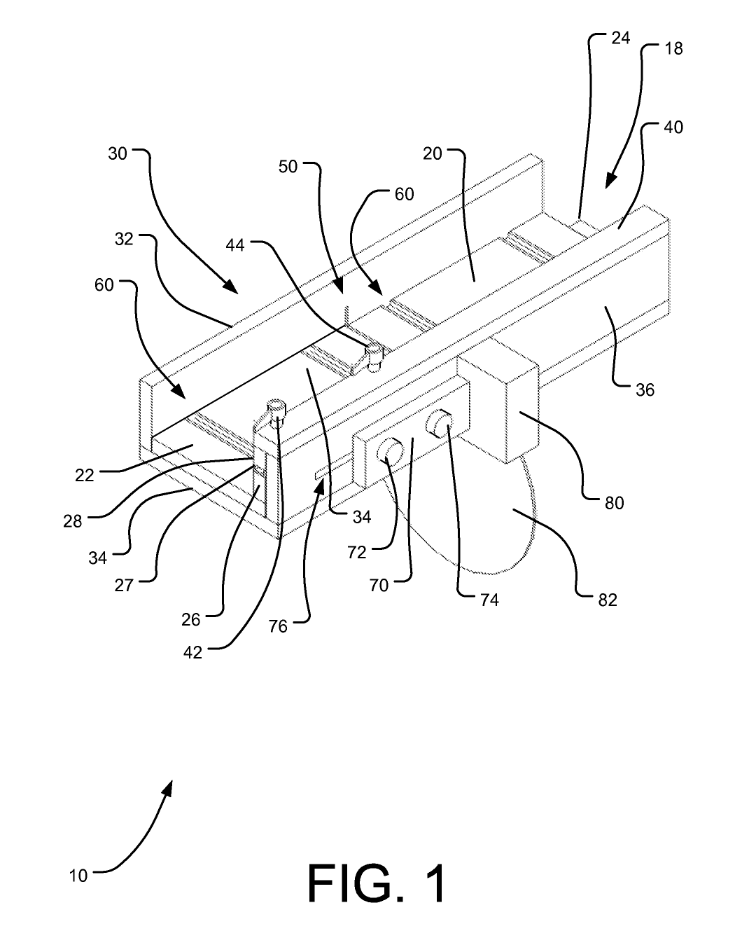

Referring now to the drawings, FIG. 1 illustrates a perspective front view of an exemplary embodiment of a precision rapid dado tool 10. The tool utilizes a sled 30 comprising a front fence 32, a sled base 34 and a rear fence 36. The sled 30 is designed to slide on top of a table saw and be operated back and forth through the use of a standard cross-cut sled. The cross-cut sled is a standard table saw accessory that is guided by a runner fastened under it that slides in a miter slot on the top of the table. By engaging the sled 30 with the cross-cut sled, the entire sled 30 can be kept perpendicular to the saw blade and moved back and forth in line with the plane of the blade. A blade 82 is shown in FIG. 1 to illustrate alignment of the sled 30; the blade 82 is not part of the invention but is instead a standard component of a table saw itself.

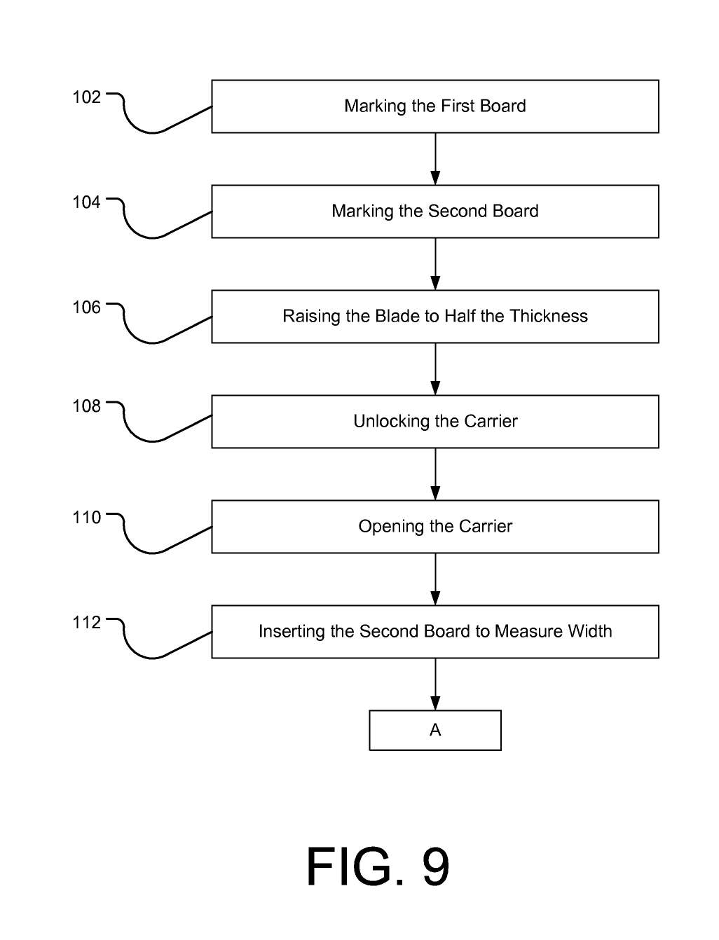

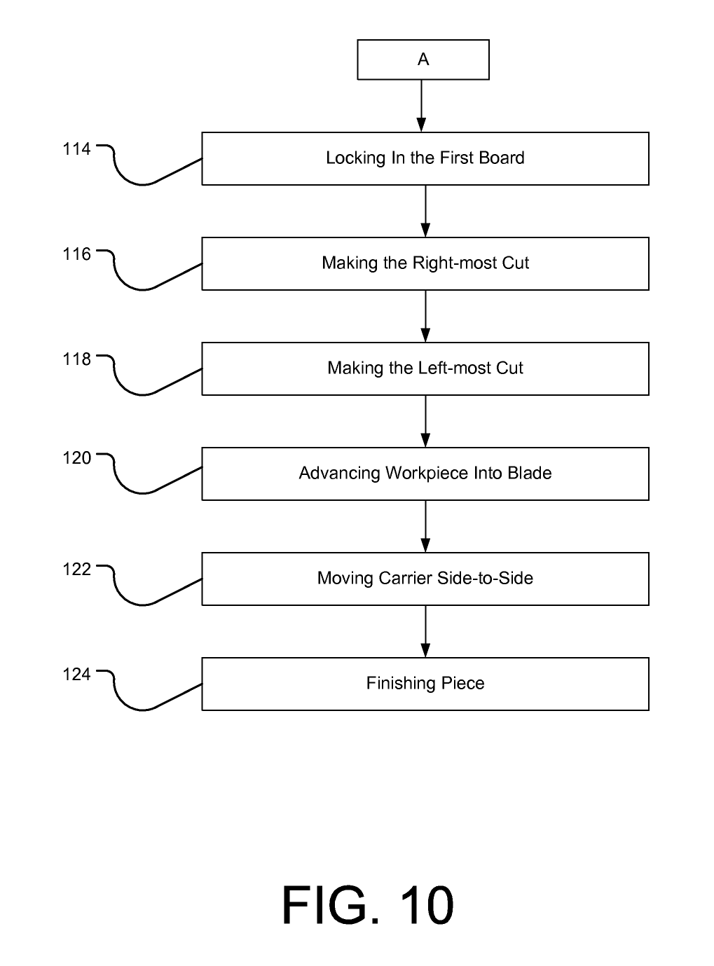

Inside the sled 30 rests the carrier 18. The carrier 18 comprises the right side carrier base 20, the left side carrier base 22, the adjustable vertical carrier member 26, the adjustment track 27, the fixed vertical carrier member 28, and the right stop 24. The entire carrier 18 can slide left and right in the sled 30 in order to allow the workpiece to move left and right relative to the sled 30 and the saw blade 82. Although not shown in FIG. 1 (see FIGS. 9 and 10), the workpiece is held firmly on top of the carrier 18 via the plurality of hold-downs 62 and 64 (again, see FIGS. 9 and 10) which are adjustable forward and backward along the plurality of blue T-tracks 60. This adjustment is necessary in order for the hold-downs 62 and 64 to be able to fit workpieces of varying size.

The measuring gauge 70 is used to quickly and easily set the width of the dado slot that will be cut into the workpiece. This is accomplished by loosening the locking knobs 42 and 44, placing the second workpiece (the one that will fit inside the dado cut on the first workpiece) between the gauge 70 and the blade guard 80, and then locking the measuring gauge 70 in place by locking the locking knobs 42 and 44 in place. The second workpiece is then removed and placed aside. The first workpiece is placed in the carrier 18 with the right alignment mark (see FIGS. 9 and 10 for creation of the alignment marks) aligned with the saw blade and then the first workpiece is locked in place via the hold-downs 62 and 64. The carrier 18 is in the left most position at this point with the right stop 24 contacting the sled 30.

The measuring gauge knobs 72 and 74 act as a tensioning device: they can be loosened or tightened to decrease or increase, respectively, the tightness of the connection between the carrier 18 and the sled 30. Although not shown in FIG. 1, the measuring gauge knobs 72 and 74 each tighten down onto a protruding end of a threaded bolt. The bolt heads are fixedly embedded in the adjustable vertical carrier member 26, and the bolt bodies extend through the slot in the rear fence 36 and through holes in the measuring gauge 70. Thus, when the knobs 72 and 74 are tightened onto the ends of the bolts, the rear fence 36 is squeezed between the adjustable vertical carrier member 26 and the measuring gauge 70. If the knobs 72 and 74 are over-tightened, the carrier 18 will no longer be free to slide within the sled 30.

The woodworker operates the precision rapid dado tool 10 by grasping the handle 40 and pushing the sled forward onto the blade 82. The blade 82 will have been previously aligned with the blade slot 50 so that the blade does not contact any portion of the sled 30. The blade guard 80 extends to the rear of the rear fence 36 and covers the blade 82; which would otherwise appear from the rear fence 36 when the sled 30 is pushed forward. The blade guard 80 can be a constructed using a clear material so that the woodworker can see the blade therein and then knows to stop pushing the sled 30 forward.

As the tool 10 is pushed forward, the blade 82 makes the right alignment cut. The tool 10 can then be pulled backward. The carrier 18 is then slid to the right until the measuring gauge 70 contacts the blade guard 80, at which point the left alignment mark will then be lined up with the blade 82. The reason the left and right alignment marks are automatically lined up is because the proper dado width was measured by the tool 10 when the second workpiece was placed between the measuring gauge 70 and the blade guard 80 and the correct alignment mark was lined up with the blade 82 when the first workpiece was locked down onto the carrier with the hold-downs 62 and 64.

At this point, the tool 10 can be slid forward once more in order to make the left alignment cut. After that cut is made, the woodworker draws the tool 10 backwards until the workpiece clears the blade. Then the sled 30 can be slid forward in small increments with the carrier 18 being slid left and right to gradually hog out the material from between the two alignment cuts. This process is repeated until the entire dado cut has been made.

The first workpiece can then be removed from the carrier 18 and the locking knobs 42 and 44 loosened. The first workpiece can then be placed between the measuring gauge 70 and the blade guard 80 in order to set the appropriate dado cut width for the second workpiece. The steps above are then repeated with the second workpiece locked into the carrier 18. Once the second dado cut is complete, the two workpieces can be joined together and the dado is complete.

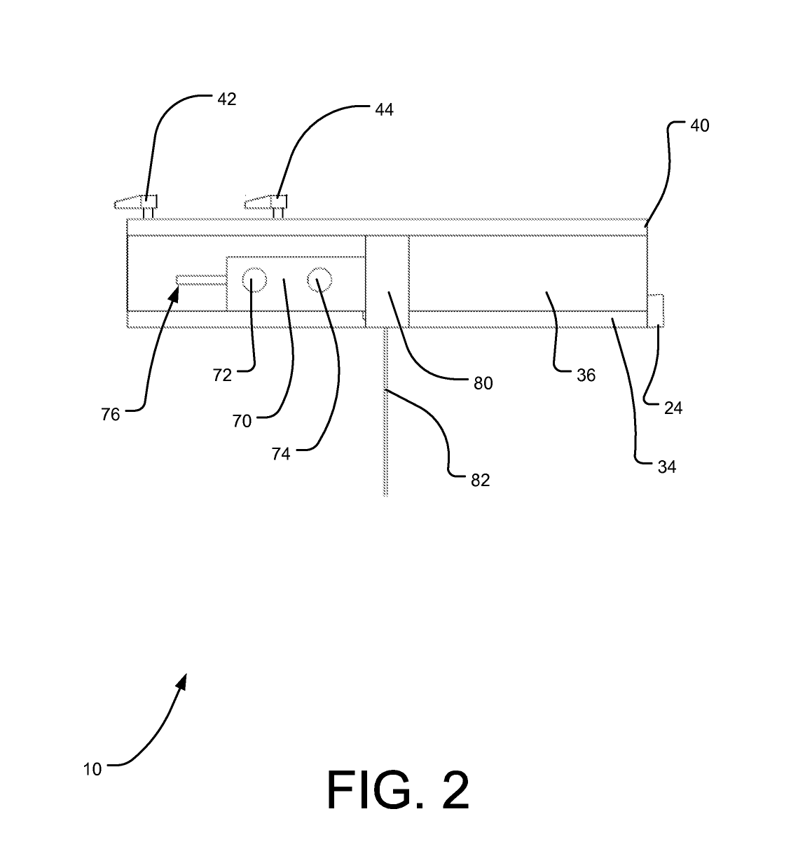

FIG. 2 illustrates a front elevation view of an exemplary embodiment of a precision rapid dado tool 10. The measurement gauge slot 76 is more clearly visible in this view versus FIG. 1. It is apparent here that the measurement gauge 70 can slide left and right in this slot 76. Also, the position of the right stop 24 is better illustrated in this view as well. The right stop 24 is connected to the right side carrier base 20 such that when the carrier is slid to the left, the right stop contacts the sled base 34 and stops further movement to the left.

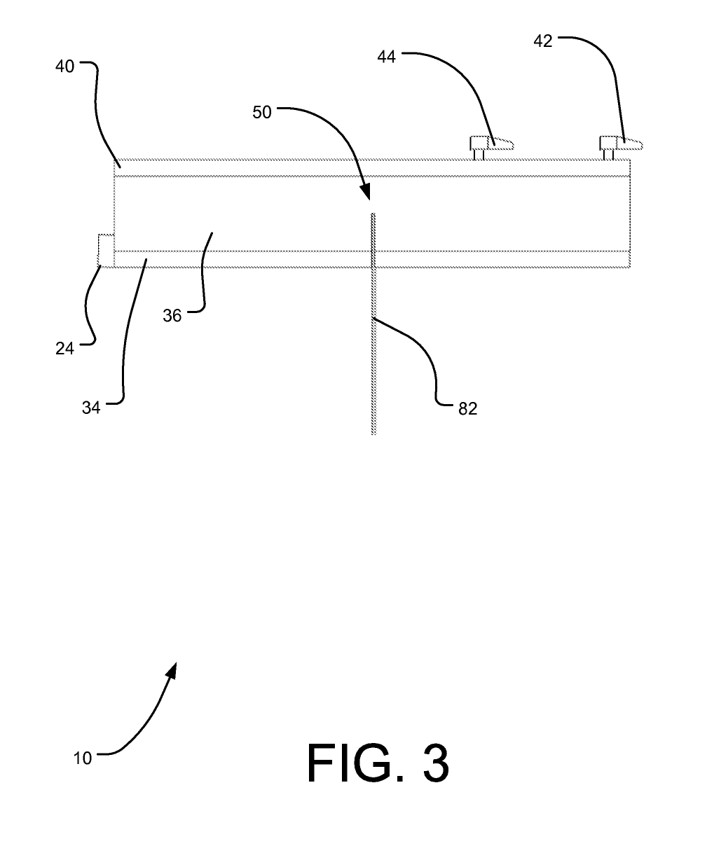

FIG. 3 illustrates a back elevation view of an exemplary embodiment of a precision rapid dado tool 10. The blade slot 50 is clearly illustrated in FIG. 3 with the saw blade 82 passing therethrough. It should be apparent that the sled portion 30 of the tool 10 does not move left and right relative to the saw blade 82 but instead only slides forward and backward with the blade 82 transiting through the blade slot 50.

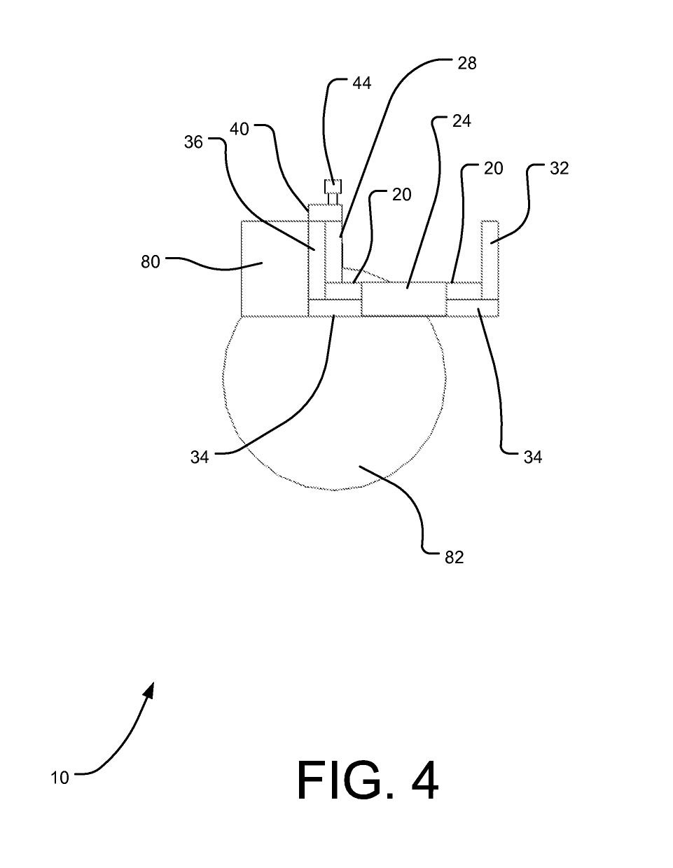

FIG. 4 illustrates a right side elevation view of an exemplary embodiment of a precision rapid dado tool 10. The right stop 24 is clearly shown. It is attached to the right side carrier base 20 and extends downwards therefrom. Thus, when the carrier 18 slides to the left, the right stop 24 contacts the right side of the sled base 34 and can not be slid any further to the left. The fixed vertical carrier member 28 is attached to the right side carrier base 20 as well as to the handle 40. The fixed vertical carrier member 28 is only fixed relative to the right side carrier base 20 and the handle 40 as it slides left and right relative to the sled 30.

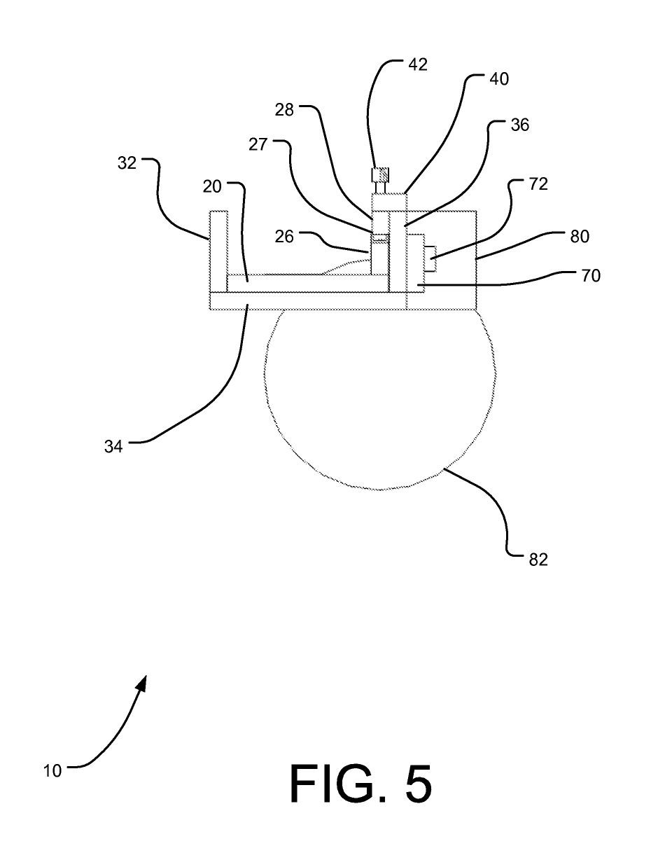

FIG. 5 illustrates a left side elevation view of an exemplary embodiment of a precision rapid dado tool 10. In the embodiment shown in FIG. 5, the handle 40 attaches to the fixed vertical carrier member 28 as in FIG. 4. However, as can be seen in this Figure, the fixed vertical carrier member 28 does not extend downwards and attach to the left side carrier base 22, as it did on the right to the right side carrier base 20. Instead, an adjustment track 27 is placed between the bottom of the fixed vertical carrier member 28 and the top of the adjustable vertical carrier member 26. The adjustable vertical carrier member 26 is affixed to the left side carrier base 22. When the locking knobs 42 and 44 are loosened, the adjustable vertical carrier member 26 (and the attached left side carrier base 22) can be slid via the adjustment track 27 right and left relative to the fixed vertical carrier member 28. Then, once the locking knobs 42 and 44 are locked, the adjustable vertical carrier member 26 is locked in place relative to the fixed vertical carrier member 26 and then the entire carrier 18 can be moved left and right as directed by the woodworker.

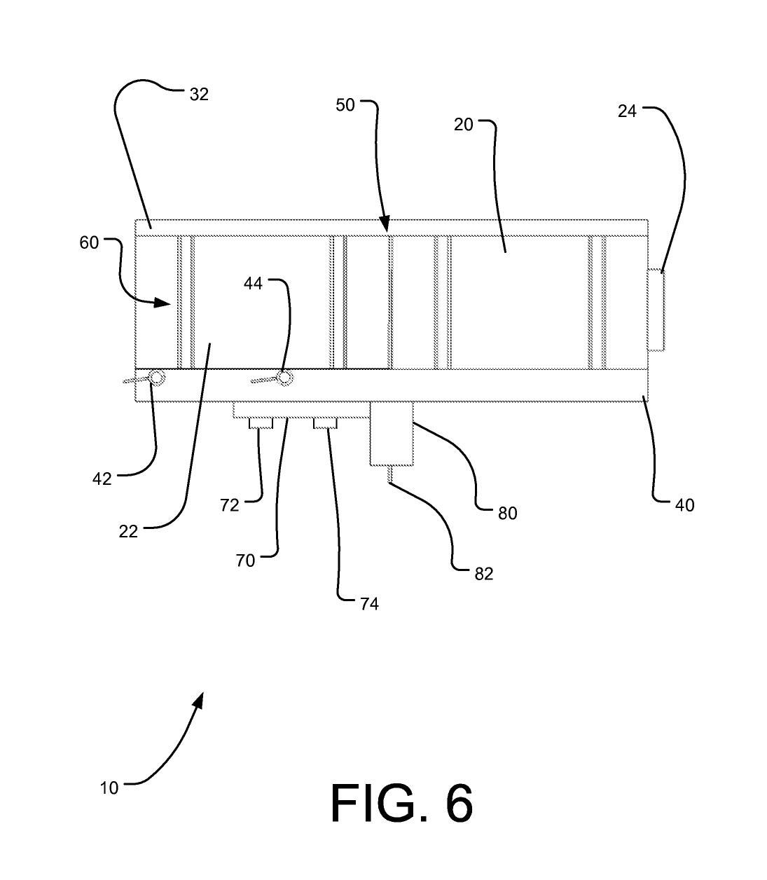

FIG. 6 illustrates a top plan view of an exemplary embodiment of a precision rapid dado tool 10. The plurality of T-tracks 60 is each highlighted in blue in this Figure. These T-tracks 60 have a cross-section with an interior open-space in the shape of an upside-down letter T. The plurality of hold-downs 62 and 64 (see FIG. 10, step 7) have a correspondingly shaped protrusion on their undersides which fit into the open space in these T-tracks 60 and allow the hold-downs 62 and 64 to slide forward and backward along the tracks until they are locked in place. The hold-downs 62 and 64 can be locked in place without holding down an associated workpiece or they can secure a workpiece onto the surface of the carrier 18. The hold-downs 62 and 64 are adjustable to fit workpieces having varying thicknesses.

The measuring gauge 70 is clearly illustrated in FIG. 6. The gauge 70 attaches to the adjustable vertical carrier member 26 via the gauge knobs 72 and 74 which extend through the measurement gauge slot 76 in the rear fence 36. The measurement gauge slot 76 is an open slot passing completely through the sidewall of the rear fence 36 of the sled 30. This arrangement serves to retain the carrier 18 inside the sled 30.

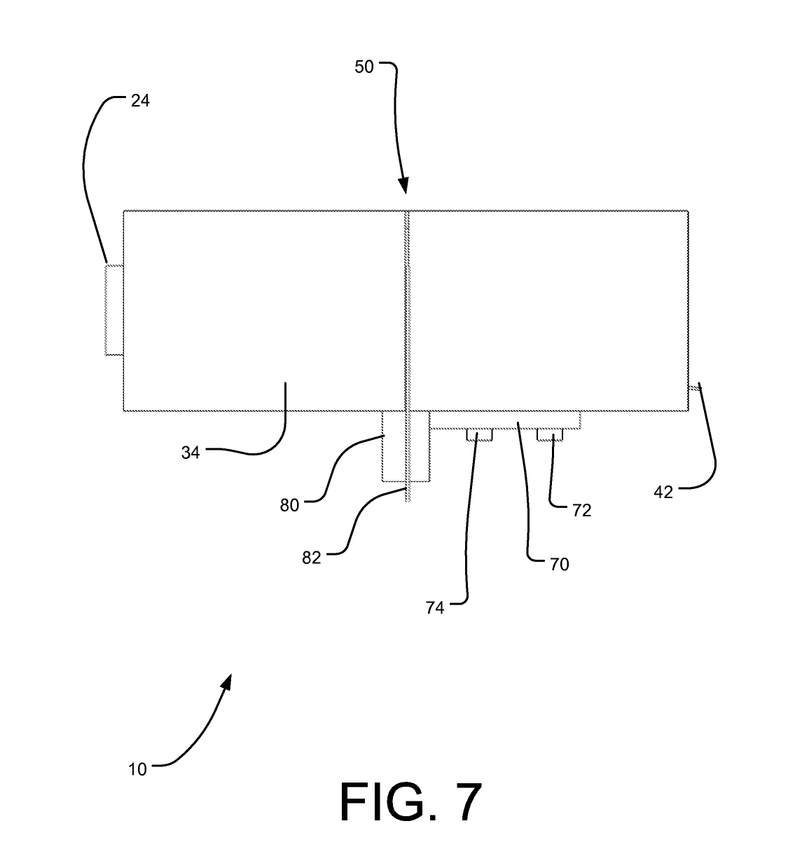

FIG. 7 illustrates a bottom plan view of an exemplary embodiment of a precision rapid dado tool 10. As shown in FIG. 7, it is preferable that the bottom surface of the sled 30 be relatively smooth so that it can slide effortlessly forward and backward on the top surface of a table saw. Alternatively, one or more runners can be adjustably fastened to the bottom of the sled 30 such that they can slide in miter slots on the surface of the table saw. In such an arrangement, a separate cross-cut sled as detailed above would not be necessary.

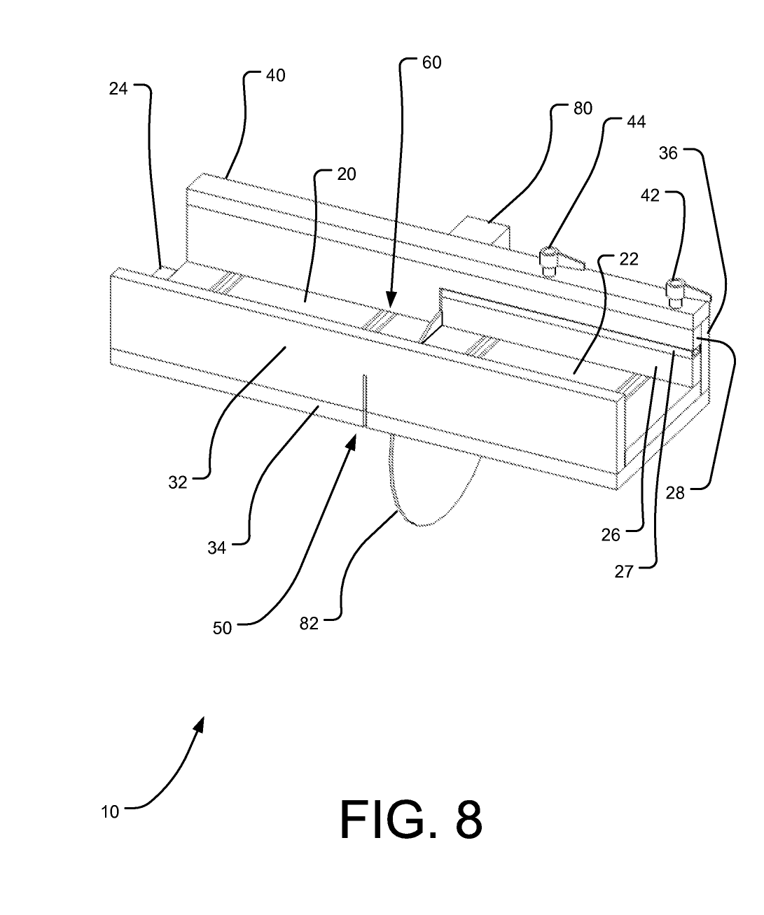

FIG. 8 illustrates a perspective back view of an exemplary embodiment of a precision rapid dado tool 10. This view highlights the adjustable vertical carrier member 26, the adjustment track 27, and the fixed vertical carrier member 28. The base of the left carrier 22, the adjustable vertical member 26, the track 27 and the measuring gauge 70 are connected to each other. Thus, when the locking knobs 42 and 44 are loosened, it loosens the whole all of those components so that they can be slid left and right. The locking knobs 42 and 44 are threaded onto bolt ends, the bolts being mounted vertically through the vertical fixed carrier 28 with the heads of the bolts sliding in the T-track of the adjustment track 27. When the locking knobs 42 and 44 are tightened, the bolt heads are drawn up tightly against the adjustment track 27, locking the track 27, adjustable vertical carrier member 26, left base carrier 22 and measuring gauge 70 to the vertical fixed carrier 28. Once locked in place, the entire carrier 18 becomes effectively a single unit that can then be slid left and right in the sled 30.

FIG. 9 illustrates an exemplary embodiment of employing a precision rapid dado tool to create a dado joint. The method shown in FIG. 9 starts with the process of Marking the First Board 102 which involves placing two workpieces next to each other in the exact position where the dado joint is desired. The width of the first workpiece is used to place the left and right alignment marks on the second workpiece. In the Marking the Second Board 104 step, the width of the second workpiece is used to place the left and right alignment marks on the first workpiece. In Raising the Blade to Half the Thickness 106, the blade 82 of the table saw is first raised to the height of the inside of the carrier 18 (which accounts for the thickness of the sled base 34 and the carrier bases 20 and 22) and then raised to further match half the thickness of the wood being dado-ed. In order to make the blade raising a quicker and more precise process, one of a set of setup bars can be used. The setup bars each have a different fixed thickness which corresponds to half the thickness of the wood to be dado-ed. The woodworker simply selects the appropriate setup bar from the set that has the thickness that is equal to half the thickness of the wood being joined. Then, the blade 82 is raised further to match the thickness of the setup bar.

In the Unlocking the Carrier 108 step, the two portions (left and right) of the carrier are unlocked from one another via adjustment of the locking knobs. Once unlocked, the left portion of the carrier can be slid left to open a gap between the measuring gauge 70 and the blade guard 80—this is the Opening the Carrier step 110.

In the Inserting the Second Board to Measure Width 112 step, the second workpiece 92 is placed within the gap and the left portion of the carrier is slid to the right until the second workpiece 92 is somewhat firmly held between the gauge 70 and the guard 80. Additional steps are referenced by the placeholder A in FIG. 9, see also FIG. 10.

FIG. 10 illustrates an exemplary embodiment of employing a precision rapid dado tool to create a dado joint. Starting at the placeholder A at the top, the first process illustrated is the Locking In the First Board 114 step, in which the first workpiece 91 is placed on the carrier and locked in place using the plurality of hold-downs 62 and 64. When the right alignment mark is in line with the blade, the hold-downs 62 and 64 are tightened. In the Making the Right-Most Cut 116 step, the tool is then pushed forward and the saw blade makes the right alignment cut. In the Making the Left-Most Cut 118 step, the carrier is slid right and the left alignment cut is made.

In the Advancing Workpiece into Blade 120 step, the workpiece is slid slightly forward (approximately one eighth of an inch is often preferable—the appropriate distance depends on the thickness of the cut, the type and sharpness of the blade, the kind of wood, etc.). In the Moving Carrier Side-to-Side 122 step, the carrier is slowly slid side to side to hog out the material between the alignment cuts. The built-in right stop and measuring gauge stops don't allow the blade to cut beyond the left and right alignment cuts that were previously made. The workpiece is gradually fed further into the blade while the left and right motions of the carrier within the sled are continued (i.e., steps 120 and 122 are repeated in sequence). In the Finishing Piece 124 step, the dado cut is complete, the saw can be turned off and the workpiece removed. Steps 108 through 124 can be repeated for the second workpiece. Once both workpieces have been cut, the dado join slots are complete and the workpieces can be fitted together, and secured as needed.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above “Detailed Description” section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. A precision rapid dado tool configured to slide on top of a table saw in order to cut a dado slot in a workpiece, the tool comprising:
a sled adapted to rest on the surface of a table saw and be slid forward and backward thereon;
a carrier slidably mounted on the sled and adapted to hold within it a workpiece;
a measuring gauge associated with the sled and the carrier;
a plurality of locking knobs;
a plurality of hold downs;
wherein the measuring gauge is adapted to set a desired width of the dado slot and said desired width can be locked into the tool using the locking knobs;
the carrier is adapted to receive the workpiece thereon and hold the workpiece down using the plurality of hold downs;
a user can cut the dado slot simply by running the sled over the table saw on each side of the dado cut and then repetitively side-to-side with small forward increments to hog out a middle of the dado, the tool adapted to only allow the saw to cut the desired width dado slot.
